(19) United States
(12) Patent Application Publication
(10) Pub. No.: US 2007/0161731 A1
(43) Pub. Date: Jul. 12, 2007

(54) Suspension of inorganic fillers in a polyesterpolyol and production method

(76) Inventors: Quintino Carvalho, Lyon (FR); Marilise Margaritelli, Paraiso (BR); Luciane Sereda, Cambui (BR)

Correspondence Address: Jean-Louis Seugnet;Rhodia Inc., 8 Cedar Brook Drive, CN 7500, Cranbury, NJ, 08512-7500, US

(21) Appl. No.: 10/569,811

(22) PCT Filed: Jul. 30, 2004
(86) PCT No.: PCT/FR04/02053

§ 371 Date: Nov. 20, 2006

(30) Foreign Application Priority Data
Aug. 8, 2003 (FR) 03 09781
Sep. 23, 2003 (FR) 03 11115

(51) Int. Cl. C08K 3/26; C08K 3/34; B60C 1/00

(52) U.S. Cl. 524/425; 524/442; 524/492

(57) ABSTRACT

The present invention relates to a suspension of an inorganic filler in a polyesterpolyol and the method for producing this suspension. It relates more especially to a stable suspension comprising, as liquid medium, a polyesterdiol compound and, as dispersed particles, an inorganic particulate filler at a weight concentration of between 0.8 and 8%. Such suspensions are used, for example, for producing polyurethanes such as polyurethane foams or thermoplastic polyurethanes.

The present invention relates to a suspension of an inorganic filler in a polyesterpolyol and the method for producing this suspension.

Polyesterpolyols, in particular polyesterdiols, are raw materials used in the field of the production of polyurethanes. Indeed, these are obtained by reaction with a compound having isocyanate functional groups and compounds having hydroxyl functional groups such as polyesterdiols.

These polyesterdiols are obtained by reaction between a diol compound such as a glycol or a polyesterdiol with one or more diacids by a conventional method for producing a polyester. Such a method generally comprises an esterification step followed by a polycondensation step.

It is known that in order to modify certain properties of polyurethanes, it may be of value to add reinforcing fillers such as inorganic particulate compounds. It is generally described that these fillers are added to the polyesterdiol or the isocyanate compound before the reaction leading to the polyurethane is carried out.

However, it is very difficult to disperse fillers in these relatively high viscosity compounds.

One of the objects of the present invention is to provide stable suspensions of inorganic fillers in a articles in which the inorganic filler is dispersed in a homogeneous manner, making it possible to obtain good properties and good appearance.

To this end, the invention provides a stable suspension comprising, as liquid medium, a polyesterdiol compound and, as dispersed particles, an inorganic particulate filler at a weight concentration of between 0.8 and 8%.

According to another object of the invention, the stable dispersion is obtained by adding the said particles to the reaction medium for esterifying the polyesterpolyol or to the reaction medium at the start of the polycondensation step.

Accordingly, the inorganic filler can be added directly to the medium, either in the form of a premix with the diol or, according to the preferred embodiment of the invention, in the form of a premix with at least part of the diacids.

Accordingly, in order to carry out this method, a very good dispersion and suspension of inorganic filler particles is obtained in the polyesterdiol and therefore a very good dispersion in the polyurethane foam that will be obtained with this suspension.

Moreover, the method of the invention, in particular the method for introducing the inorganic filler in the form of a mixture with diacids makes it possible to obtain a stable suspension. It is therefore possible with the method of the invention to prepare suspensions based on a polyesterdiol and to store these before using them for producing polyurethanes.

This method also makes it possible to obtain stable dispersions at higher concentrations of inorganic fillers.

In the preferred embodiment of the invention, the mixture of filler with diacids can be obtained by mixing diacid granules or powders with inorganic filler particles at ambient temperature, for example, or at a temperature between ambient temperature and 120° C.

It is also possible to coat the inorganic filler particles with part of the diacids. This coating is obtained by heating the mixture to a temperature above the melting point or softening point of the diacids.

In this embodiment, the inorganic filler particles are advantageously coated with a diacid having a number of carbon atoms less than or equal to 5, such as glutaric acid or a mixture of diacids containing a diacid having 5 carbon atoms or fewer such as the mixture of diacids called AGS.

As diols suitable for the invention, mention may be made of glycols having 2 to 10 carbon atoms, preferably 2 to 6 atoms, such as ethylene glycol, diethylene glycol, 1,4-butanediol, 1,5-pentanediol, 1,6-hexanediol, 1,10-decanediol, 2,2-dimethyl-1,3-propanediol, 1,3-propanediol, dipropylene glycol, trimethylolpropane, glycerol, pentaerythritol, diglycerol, dextrose, sorbitol, bisphenol, hexylene glycol or equivalents. These diols can also be used mixed.

As examples of dicarboxylic acids, mention may be made of aliphatic diacids such as adipic acid, succinic acid, glutaric acid, suberic acid, azelaic acid, sebacic acid, pimelic acid, aromatic acids such as phthalic, isophthalic, terephthalic and naphthenic acids, and unsaturated aliphatic acids such as maleic acid, fumaric acid and itaconic acid. These diacids can be used individually or mixed.

According to yet another preferred embodiment of the invention, the diacids used for the formation of the polyesterdiol advantageously consist of a mixture of adipic acid and a mixture of diacids called AGS which is obtained as a by-product in the method for producing adipic acid by oxidation of cyclohexanol and/or of cyclohexanone and which comprises adipic acid, succinic acid and glutaric acid.

It is also possible to use derivatives of these diacids, such as diesters having 1 to 4 carbon atoms and for the remainder derived from the alcohol, acid anhydrides and acid chlorides.

According to the invention, the dispersions of polyesterdiols containing an inorganic filler are obtained according to a method comprising two steps, a first esterification step and a second polycondensation step.

The esterification step is carried out by mixing the diacids with diols, for example a mixture of ethylene glycol and diethylene glycol, with a diol/diacid molar ratio of between 1.2 and 1.5.

The reaction temperature in this first step is increased progressively as the reaction advances. As an example, the start of the reaction is carried out at a temperature of 160° C. to arrive at a temperature of 220° C. at the end of the reaction.

According to the invention, the diacids are advantageously added as a mixture with the inorganic filler, as described previously.

The second polycondensation step is carried out with the addition of a catalyst such as tetrabutyl titanate (TBT), for example, in a weight concentration between 0.001% and 0.010% based on the weight of diacids involved. The polymerization temperature is 200° C. at a pressure of between 10 and 20 mbar.

The polyester diol obtained is characterized by the hydroxyl number (I_{OH}) corresponding to the number of mg of potassium hydroxide per gram of polyol to convert the hydroxyl functional groups into an alcoholate, and an acid number (I_{A}) which represents the number of mg of KOH necessary to neutralize 1 g of polyol.

The polyesterdiol is also characterized by the viscosity by its molecular weight.

Accordingly, the polyesterpolyol advantageously has a number-average molecular weight of between 5000 and 8000, preferably between 6000 and 7000.

Other advantages and details of the invention will become more clearly apparent in the light of the examples given solely as an indication.

### COMPARATIVE EXAMPLE 1

Suspensions of silicas marketed by Rhodia under the trade names indicated in Table 1 below and having the principal properties indicated, were prepared by adding silica to a polyesterdiol with a molecular weight of approximately 7000. The silica dispersion was obtained with the aid of a mechanical mixer of the ULTRA-TURRAX type during approximately 5 minutes.

TABLE 1

| | BET specific surface area | Particle size |
|---|---|---|
| Silica | (m²/g) | (nm) |
| Tixosil 365 | 147.9 | 45-50 |
| Aerosil 200 | 200 | 12 |

The characteristics of the suspensions obtained are given in Table 2 below

TABLE 2

| | | Viscosity (mPa · s) |
|---|---|---|
| | | (measured at 34° C. with a |
| Ex. | Polyol | 20 rpm torque) |
| 1a | No silica | 5.100 |
| 1b | Silica T 365 | >10.000 |
| | (0.65% by weight) | |
| 1c | Silica A200 | The mixture did not flow |
| | (0.65% by weight) | for temperatures below 70° C. |

Suspensions 1a and 1b were used to produce polyurethane foams according to the formula described in Table 3 below:

TABLE 3

| Components | Quantity by weight (g) |
|---|---|
| Polyol | 100 |
| Chain extender | 14 |
| Foam-forming agent | 0.1 |
| Silica | 5 |
| Catalyst | 1.2 |
| Surfactant | 0.2 |
| Diisocyanate prepolymer | 129.3 |
| NCO/OH molar ratio | 1.12 |

The foams obtained with these suspensions were not suitable since the silica formed aggregates that degraded the properties of the foam.

### EXAMPLE 2

A suspension of silica in a polyesterdiol according to the invention was obtained according to the following procedure:

In a first step, adipic acid mixed with 6% silica marketed by Rhodia under the trade name TIXOSIL T365 was added to a mixture of ethylene glycol (MEG) and diethylene glycol (DEG) containing 70% by weight of MEG.

The molar ratio between the alcohols and the diacid was between 1.2 and 1.5.

The reaction was carried out by heating the mixture at 160° C. for 1 hour and the temperature was then increased in 15° C. steps to 215° C. This reaction was carried out in an inert atmosphere, for example nitrogen.

The esterified compound obtained was polycondensed in a second step after adding tetrabutyl titanate (TBT) at a weight concentration of 0.003% based on the quantity of diacids added.

Polymerization was carried out at 200° C. at a reduced pressure of 15-18 mbar.

The polyesterpolyol obtained was characterized by the OH index (I_{OH}), the acid number (I_{A}) and the viscosity as indicated below:
ADOH/SiO₂ (mass ratio): 94/06
MEG/DEG (molar ratio): 70/30
I_{OH} of 55.86 mg of KOH/g of polyol
I_{A} of 0.43 mg of KOH/g of polyol
A viscosity of 6500 mPa·s at 34° C.

The suspension obtained in this way was stable and did not exhibit any settling after 5 days storage at 70° C.

It could be used as components for polyurethane production according to the usual methods for polyurethane production.

As an example, the use of this suspension is described below for the production of a low-density polyurethane foam.

Polyurethane foams were obtained by using the compounds and proportions indicated in Table 4 below.

TABLE 4

| Products | Proportion (g) |
|---|---|
| Polyol | 100 |
| Chain extender (Ethylene glycol) | 8.83 |
| Water | 1.23 |
| Catalysts | 2.6 |
| Surfactant | 1.3 |
| Isocyanate prepolymer | 167 |
| NCO/OH molar ratio | 1.25 |

The properties of the foams obtained were:
Density: 0.21±0.01 g/cm³
Hardness (Ascher C): 49±1
Tensile stress at break: 26.6±1.1 kg/cm³
Elongation at break: 280±8%
Resistance to tear propagation: 2.34±0.17 kg/cm
Tear resistance: 9.9±0.5 kg/cm
Deformation resistance (compression set): 3.8±0.4%

The properties of the foam were determined according to the methods indicated below:
The density, also called apparent density, was determined according to ASTM D3574(A) standards (Cellular plastics and rubbers—Determination of apparent density corresponding to the ISO 845 standard).
Hardness was determined according to the NBR 14455 (Ascher C) standard (Cellular materials, materials for soles and parts of shoes corresponding to the DIN 53543 standard).
The tear resistance of the foam was determined according to the ASTM D 3574 (F) standard.
Elongation at break was determined according to the ASTM D 412 (C) standard.
Tensile stress at break was determined according to the ASTM D 412 standard.
Shrinkage during moulding was measured according to the SATRA TM 70 standard (Heat shrinkage of cellular soling).
Permanent deformation under load (compression set) was determined according to the ASTM D 395 (B) standard (Flexible cellular polymeric materials corresponding to the ISO 1856 standard).

### EXAMPLE 3

Example 2 was repeated, but using a mixture of diacids and silica containing adipic acid, 6% by weight of a mixture of diacids called AGS and 6% by weight of silica. The mixture used in Example 3 was obtained by mechanically mixing the three components.

The characteristics of the polyesterdiol suspension obtained were:
ADOH/SiO₂/AGS (mass ratio): 88/06/06
MEG/DEG (molar ratio): 70/30
I_{OH}: 51.8 mg of KOH/g of polyol
I_{A}: 0.70 mg of KOH/g of polyol
Viscosity: 10850 mPa·s at 34° C.

This suspension was stable and did not exhibit any settling after 5 days storage at 70° C.

As for Example 2, a low-density polyurethane foam was produced according to the procedure and proportions given in Example 2.

The foam obtained had the following characteristics:
Density: 0.20±0.01 g/cm³
Hardness (Ascher C): 56±2 (Manual)/52±2 (Norm)
Tensile stress at break: 23.00±1.70 Kg/cm³
Elongation at break: 293±23%
Resistance to tear propagation: 2.83±0.34 kg/cm
Tear resistance: 10.1±0.7 kg/cm
Deformation resistance (compression set): 5.6±0.8%

1-11. (canceled)

12. A stable suspension comprising a polyesterdiol and a particulate inorganic filler at a weight concentration of between 0.8% and 8%.

13. A method for producing a suspension as defined in claim 12, made by:
a) reacting a diol compound with a diacid in a first esterification reaction medium to obtain a hydroxyester,
b) polycondensing the hydroxyester obtained in step a) to the desired degree of polymerization in a polycondensation reaction medium, and
c) dispersing the inorganic filler in the esterification reaction medium step a) or the polycondensation reaction medium of step b).

14. The method according to claim 13, wherein the inorganic filler is premixed with the diol before adding it in the esterification step a).

15. The method according to claim 13, wherein the inorganic filler is premixed with the diacid or diacids before adding it in the esterification step a).

16. The method according to claim 13, wherein the inorganic filler is aluminosilicate, silica, titanium oxide, talc or calcium carbonate.

17. The method according to claim 16, wherein the inorganic filler is a precipitated silica.

18. The method according to claim 13, wherein the diacid is an aliphatic diacid, aromatic acid or an unsaturated aliphatic acid.

19. The method according to claim 18, wherein the diacid is adipic acid, succinic acid, glutaric acid, suberic acid, azelaic acid, sebacic acid, or pimelic acid.

20. The method according to claim 18, wherein the aromatic acid is phthalic, isophthalic, terephthalic or naphthenic acid,

21. The method according to claim 18, wherein the unsaturated aliphatic acid is maleic acid, fumaric acid or itaconic acid.

22. The method according to claim 18, wherein the diacid is adipic acid or an adipic acid/AGS mixture.

23. The method according to claim 13, wherein the diol is a glycol having 2 to 10 carbon atoms, optionally 2 to 6 atoms.

24. The method according to claim 23, wherein the diol is ethylene glycol, diethylene glycol, 1,4-butanediol, 1,5-pentanediol, 1,6-hexanediol, 1,10-decanediol, 2,2-dimethyl-1,3-propanediol, 1,3-propanediol, dipropylene glycol, trimethylolpropane, glycerol, pentaerythritol, diglycerol, dextrose, or sorbitol.

25. The method according to claim 13, wherein the polyesterdiol has a number-average molecular weight of between 5000 and 8000.

26. A polyurethane comprising a suspension of an inorganic filler in a polyesterdiol obtained by the method of claim 13.
